(19) United States
(12) Patent Application Publication
(10) Pub. No.: US 2008/0270532 A1
(43) Pub. Date: Oct. 30, 2008

(54) Techniques for generating and applying playlists

(75) Inventors: David P. Billmaier, Woodinville, WA (US); James A. Billmaier, Woodinville, WA (US); David Dederer, Medina, WA (US); Robert M. Wise, Issaquah, WA (US); Alexander C. Barclay, Seattle, WA (US); AJ Cram, Seattle, WA (US)

Correspondence Address: FSP LLC, P.O. BOX 890, VANCOUVER, WA, 98666, US

(73) Assignee: Melodeo Inc., Seattle, WA (US)

(21) Appl. No.: 12/077,246

(22) Filed: Mar. 17, 2008

Related U.S. Application Data
(60) Provisional application No. 60/977,309, filed on Oct. 3, 2007.
(60) Provisional application No. 60/896,329, filed on Mar. 22, 2007.
(60) Provisional application No. 60/942,165, filed on Jun. 5, 2007.

(51) Int. Cl. G06F 15/16

(52) U.S. Cl. 709/203

(57) ABSTRACT

A server system applies content and usage data from a user's client-side music and/or video library to determine recommended content to include in a playlist for the user.

### PRIORITY CLAIM

The present application claims priority under 35 USC 119 to U.S. provisional application no. 60/977,309, filed on Wednesday, Oct. 3, 2007, U.S. provisional application no. 60/896,329, filed on Thursday, Mar. 22, 2007, U.S. provisional application no. 60/942,165, filed on Tuesday, Jun. 5, 2007, each of which is incorporated herein by reference.

### BACKGROUND

People collect music, video, and other content into personal libraries, which are typically stored in a unified or distributed fashion by various electronic devices. When the content is stored or accessible only through multiple devices, it becomes difficult for the user to experience a unified and consistent media experience from any one device. Restrictions imposed by digital rights management exacerbate this difficulty. People may also lose the benefit of content recommendations due to the fact that there is no central knowledge of their content preferences, usage patterns, and general behavior.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of a system for creating and executing content playlists.

FIG. 2 is a block diagram of a client device that may operate in the system of FIG. 1.

FIG. 3 is a block diagram of a user interface for a client device in the system of FIG. 1.

FIG. 4 is an example of playlist formation that is location and/or presence-specific.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

Those skilled in the art will appreciate that logic may be distributed throughout one or more devices, and/or may be comprised of combinations of instructions in memory, processing capability, circuits, and so on. Therefore, in the interest of clarity and correctness logic may not always be distinctly illustrated in drawings of devices and systems, although it is inherently present therein.

Playlist Creation System

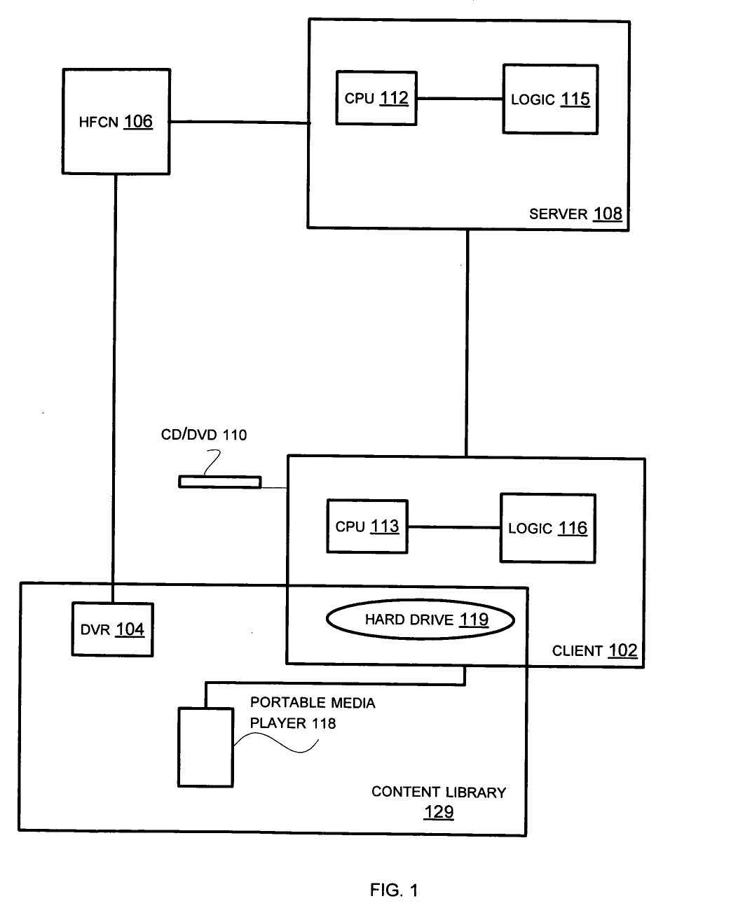

FIG. 1 is a block diagram of a system for creating and executing content playlists. A server system 108 includes one or more processors 112 and logic 115 to carry out aspects of the processes and techniques described herein. Of course, the server system 108 will often include many other components (mass storage, volatile memory, data busses, etc.) that will be understood by those skilled in the art to be present, but are not necessary to the present description. The server system 108 may include one or more computer systems accessible via the Internet or other networking systems, in manners known in the art.

A client system 102 also includes one or more processors 113 and logic 116 to carry out aspects of the processes and techniques described herein. Like the server system 108, the client system 102 will often include many other components (mass storage, volatile memory, data busses, etc.) that will be understood by those skilled in the art to be present, but are not necessary to the present description. The client system 102 may include logic to access and communicate with the server system 108 via the Internet or other networking systems, in manners known in the art. Typically, the server system 108 is designed to interact with many client systems 102 more or less at the same time.

The client system 102 also includes a mass storage device, such as a hard drive 119, upon which is stored, among other things, all or portions of the content library 129 of a user of the client 102. The content library 129 may include audio data, such as music tracks in the form of, for example, MP3 format files. The content library 129 may also include video data (and audio/video data) in the form of video clips or other video content, for example in MPEG (Motion Picture Experts Group) format. These are merely examples of the type of content one might expect to find in a user's content library 129.

The user's content library 129 may span multiple sources. For example, the content library 129 may comprise content from the hard drive 119, from a portable media player 118, from one or more CD/DVD devices 110, from a Digital Video recorder 104, and so on. The content library 129 may be referred to herein as the client-side music and/or video library, or as the ‘user's library’, or simply as the ‘library’. The term ‘client-side’ means coming from or provided by the client device.

Content and usage data (content metadata and usage data) from a user's client-side music and/or video library may be uploaded from the client 102 to the server system 108. The upload may occur via various mechanisms, such as the Internet, private networks, wireless networks, or a cable television network (e.g. via a Hybrid Fiber Coaxial Network 106). The server system 108 may apply this meta and usage data to determine one or more playlists for the user, and/or recommended content to include in the playlists for the user.

Content from the playlists may be streamed from the server 108, and/or played to the user from sources local to the client device 102 (the hard drive 119, CD/DVD 110, portable music player 118, etc.). Typically, the playlist will include references to content in the user's library 129, and also to recommended content that isn't in the user's library 129. The recommended content may be streamed to the client 102 from the server 108, while the content from the user's library 129 is played from local sources. Depending on the situation and implementation, the server 108 may stream all of the content referenced by the playlist, even if some of it is also available from local sources.

Exemplary metadata includes author/actor/artist/publishing information about the content, as well as thumbnails, album art, artist images, and so on. Exemplary usage data includes the time the content was acquired into the library, the number of times the content has been played, how much of the content was actually played out each time, the timestamp when each play occurred, the source of the content (downloaded, ripped, purchased, etc), user ratings of media, the history of sharing the content with other users, and consumption patterns of the content by other users (this may be determined not exclusively from a particular user's uploaded information, but rather by analyzing many uploads by many users).

Other examples of usage data include a number of times the content is sideloaded/downloaded to a mobile device (e.g. a portable music player 118), and the bitrate/codecs used to encode the content, including alternate copies (users might keep multiple copies of the same media at different bitrates). Usage data may also include the user's favorite artists/authors/actors, specific times of day/days/dates when the content was played, which content was skipped during play from a playlist, which content was deleted from playlists and/or from the library 129. Usage data may also include the content of playlists themselves—what content they reference, when they were played, when they were accessed, and when they were changed. Of course, these are only non-exclusive examples of metadata and usage data.

As described below, playlists may then be formed that include references to content of the user's library 129, and other content that is not in the user's library 129 but that is perhaps related or recommended in some fashion.

Thus, the content and usage data from a client-side music and/or video library may be applied by the server system to determine recommended content for user playlists, where the recommended content that is not content in the user's music and/or video library 129. The recommended content, which is not in the user's library 129, may be streamed from the server 108 to the client device 102 (or another device that was not the source of the content/usage data) when executing the playlist. Because content of the playlist is streamed to the client 102, it may be necessary to form the playlist in conformity with Digital Millennium Copyright Act (DMCA) radio station regulations. These regulations specify, for example, how often certain musical tracks may be streamed, how much time must elapse between streaming tracks that are related in certain ways, and so on. In some cases, however, the server system 108 may analyze the metadata and usage data and determine that particular content of the user's library 129 was most likely purchased. In this case, it may be possible to relax or eliminate DCMA radio station regulations with respect to the playing of the purchased content.

The playlist may reference only content that is available for streaming from the server system 108 (or an affiliated system). In this case, it may be possible for the user to enjoy the experience of their content library from very “thin” devices, such as cellular phones, which may lack the capacity to store their entire library. A playlist may also be formed that includes references to local content of the client system 102, and references to content streamed from the server system 108. A “hybrid” playlist such as this may enable a mixed playlist including recommended content that isn't in the user's library 129 and content from their library or other local sources, such as CDs/DVDs 110, portable media devices 118, and so on.

The system 108 may consider other factors when recommending content for playlists. For example, the system 108 may compare content and usage data to data provided by content owners and/or creators in order to select recommended content for the playlist that is not in the user's library 129. This gives content owners/creators/promoters some influence on when their content is recommended, and provides another potential source of revenue.

Content Library Experience on Other Devices

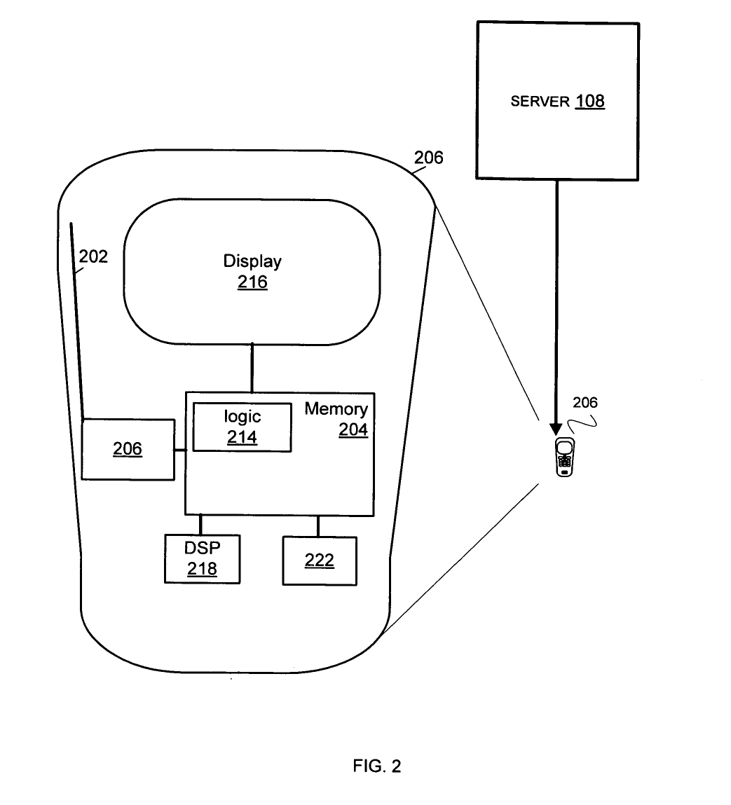

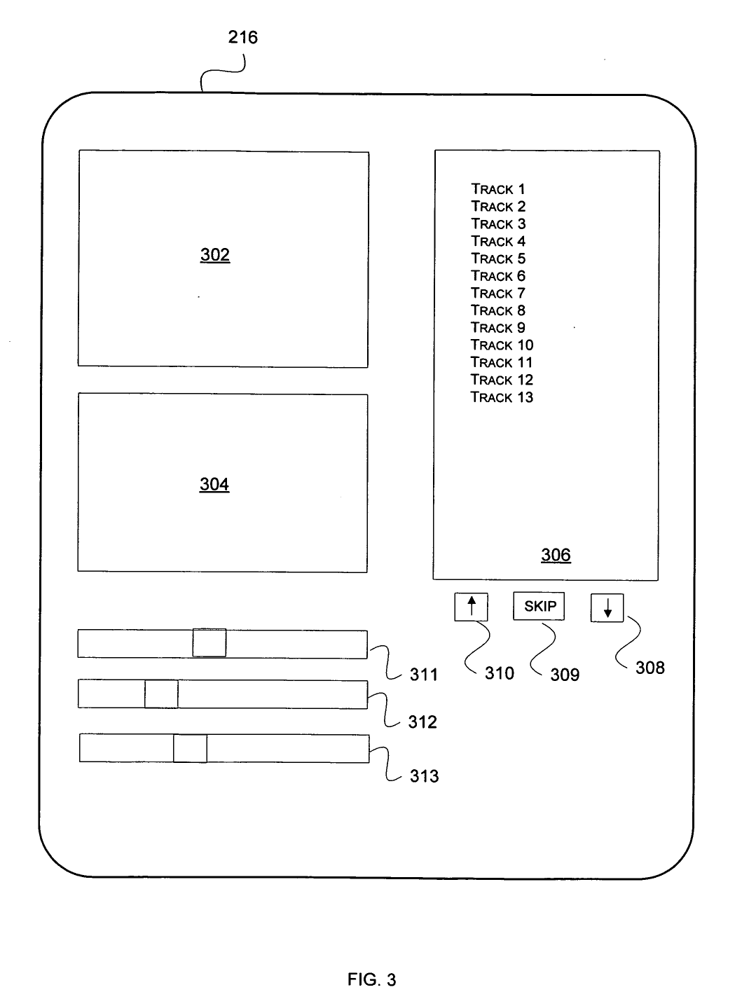

FIG. 2 is a block diagram of a client device that may operate in the system of FIG. 1. The server 108 may stream content to a client device 206 that was not the source of the content/usage data, or which does not host the user's content library 129. An example of a device that may receive the playlist streams is a cell phone. The cell phone 206 or other device may include logic 214 and other components that enable the device to receive and play the streams from the server, and/or to play content stored locally. The device 206 may host a user interface (UI) for playing the streams, such as the UI described in conjunction with FIG. 3.

In the example of FIG. 2, the client device 206 is a wireless device that includes one or more antennae 202, a display 216, wireless communication logic 216, memory 204, nonvolatile storage 222, and at least one digital signal processor (DSP) 218, among other things. These components may operate cooperatively to carry out aspects of the techniques described herein. Although designed and operated primarily as a communication device, the client 206 in this case may effectively operate as a portable music player for the user's content library 129, because the server 108 makes that library available as streams, in addition to providing recommended content that is not in the user's library 129.

User Interface

FIG. 3 is a block diagram of a user interface for a client device in the system of FIG. 1. The user interface (UI) may be hosted on a client device 206 display 206 and may be generated and operated by logic 214 operating on the client device 206. The UI may include a panel 302 for content metadata (information about the album, artist, track, etc.) and a panel for advertising content 304.

When the server system 108 forms a playlist 306, the ratio of in library/not in library content may be determined by a client control, in some cases a slider. Item 311 is an example illustration of such a slider control. The control 311 may determine a ratio in the playlist 306 of content from the user's library (or other local sources) and content recommendations streamed from the server 108 that are not in the user's library 129. This control may be referred to as a “serendipity slider”. Likewise, in the playlist 306, the closeness of the similarity or suitability of the not-in-the-library content to content in the library may be determined by a client control, also in some cases a slider. Item 312 is an example illustration of such a slider control.

In some cases, the server 108 may include references to advertising content in the playlist 306. A client-side control may be provided to allow the user to determine how much advertising content is included in the playlist and/or the ad panel 304. For example, a slider control 313 may allow the user to balance how much of a subscription fee they pay against how much advertising content they are subjected to in their playlists and/or ad panel 304.

People often tire of certain songs, or they don't like songs that are recommended into their playlists. A client-side control 310 (such as a ‘thumbs-up’ button) may be provided to enable users to approve or disapprove of certain content. The same or another control 308 (e.g. a ‘thumbs down’ button) may provide for an expression of disapproval. An indication of disapproval may cause the content to be removed and/or recommended less often. Likewise, and expression of approval may result in the content appearing more often and/or more prominently in future playlists for this or other users.

Often, users will decide to skip a particular piece of content when its time comes for playing from the playlist. A skip control 309 may be provided for this purpose. The skip control 309 may act as or supplement the controls for showing approval/disapproval 308, 310. Skipping is complicated by the need to comply with DCMA regulations (also see above). Invoking the skip control 309 may thus cause playing to skip to content in the playlist that is not sequentially next content in the list, but rather is permitted content that can be skipped to and played while complying with DMCA radio station regulations. For example, the system may direct play to content that has been purchased by the user. After skipping to and playing one or more items of permitted content, the system may next direct the playlist execution to content that would have been skipped to originally, except that so doing would have violated DMCA radio station regulations. In order to make the skipping experience more natural and smooth, the system may provide priority caching of portions of content (e.g. first ten seconds of musical tracks that are permitted skip destinations from the current track) and/or information about the content (logos, album cover art, metadata, and so on) that can be skipped to from present content without violating DMCA regulations.

The use of one- or two-dimensional sliders or other ratio and/or percentage controls may be extended to further customize the user's playlist experience. For example, a user may be provided with UI controls that provide for setting the percentage and/or ratio of various content types in the playlists provided by the server system 108. Examples include:

A control to set the ratio/percent of content belonging to or related to one or more genres (rock, classical, movie, TV, adventure, etc).

A control to set the ratio/percent of content belonging to or related to one or more sub genres.

A control to set the ratio/percent of content appealing to or related to one or more user demographic (age, sex, etc).

A control to set the ratio/percent of content appealing to, recommended by, associated with, or related to one or more friends of the user, and/or to set which friends have more influence on content selection.

A control to set the ratio/percent of content contributing to one or more moods.

A control to set the ratio/percent of content belonging to or related to one or more rating (G/PG, R, explicit/non-explicit, and so on).

A control to set the ratio/percent of content having religious/cultural content.

In some implementations the various controls may be arranged into a ‘mixer board’ where the user can go to highly customize their content experience. It may be the case that adjusting one control to increase a percentage and/or ratio of a certain type of content in playlists may have the effect of decreasing or otherwise adjusting the ratio of other content types in the playlist.

Sliders are merely one way of expressing percentages and ratios for content type. Other manners of expression may include, for example, pie charts and bar charts. In some cases, the user may wish to describe content having multiple types, e.g. content which falls into multiple categories or types or which has characteristics associated with multiple categories or types. One manner of expressing inclusion in multiple sets is the Venn Diagram. Thus, a UI may include facilities for describing content types, ratios, percentages, and characteristics by way of, for example, pie charts, bar charts, and/or Venn Diagrams.

Location-Specific Playlists

In some cases, the server system may apply information about the user's location to determine content for the playlist. This enables the user to enjoy a media experience that is localized. For example, the system may use information about the user's location at or in a business, entertainment establishment, or other facility where the user is presently located to determine content for the playlist. One example would be forming a playlist based on what other content is currently being listened to in the building, facility, organization, social setting, or geographical area where the user is located. Coffee shops, restaurants, night clubs, bars, or other social gathering places are some examples. The system may have this knowledge from other users that it is servicing in the same general or specific area.

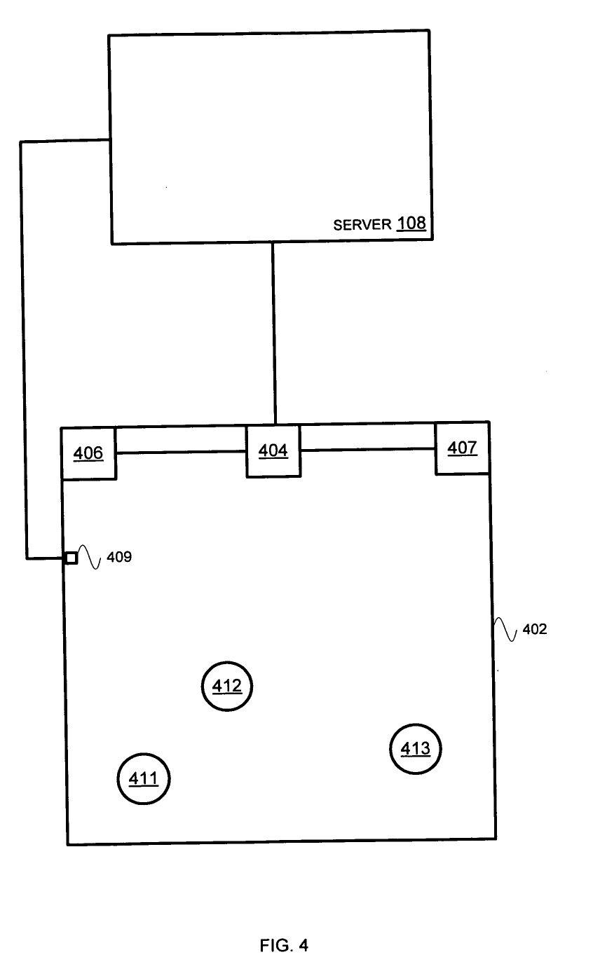

FIG. 4 is an example of playlist formation that is location and/or presence-specific. A location 402 may have present a number of people 411-413. The server 108 may detect the presence of these people 411-413 via, for example, a Wi-Fi terminal hot spot 409. The server 108 may form one or more playlists tailored to the tastes of the people 411-413 and/or the location 402. Content from the playlist may be streamed to a receiver 404 the location 402, from which it may be distributed to players 406, 407 (e.g. speakers, display screens, etc.).

Content selected for the playlist may be based on metadata/usage data for one or multiple parties 411-413 at the location 402. Content from the playlist may be rendered to a single user (e.g. via headphones) or via a more public mechanism, such as speakers, video screens, and so on that form an ambient audio/visual experience for the patrons of a particular establishment. The system may determine who is located at the location 402 using one or more of GPS, Wi-Fi, Bluetooth, or credit card transactions, for example. People 411-413 may be allowed to make recommendations to the system for content of the location-specific playlist, and if accepted, the content when played at the location 402 may include an attribution to the person who recommended it.

Context-Specific Playlists

As previously described, the usage data may include one or more of how often a song is played, locations in which a song is played, time and/or dates when a song is played. Usage data may also include the context of the user's client device. The context of the user's client device may include one or more user activities involving the client device, such as web browsing, watching video, and listening to music. The server system 108 may thus select content for the playlist (both library and recommended content) that is related to one or more of what is or has been browsed, what is or has been watched, or what is or has been listened to by the user. Examples would be selecting content related to one or more of a person, show, event, subject, place, product, or activity that is or was browsed, watched, or listened to. One more specific example would be the server system 108 forming playlist including content related to one or more of content currently or previously viewed, recorded, or scheduled for future recording by a DVR device 104.

The system may also allow artists/owners/promoters to promote their content by providing compensation to improve the position and/or likelihood of placement of content in playlists. A related application would be selecting (perhaps with attribution) content for the playlist that was recommended for the user by a third party, and/or selecting content for the playlist according to one or more of a social network, group, organization, or demographic to which the user belongs.

In some cases, the system may determine demographic and/or preference information for the user from the content and/or usage data. This may prove useful in product promotions and advertising selection. The system may adapt the demographic and/or preference information over time as more usage data is acquired.

Some implementations may go beyond collection of metadata and usage data, and may actually upload content from the user's library 129 to the server 108, from which the content may be streamed back to the user's client device 102 (206). This would enable the user to take their content experience anywhere, and to any device capable of receiving streams, even if such devices weren't authorized “fair play” devices for protected content. For example, when uploaded content is protected by digital rights management (DRM), the server 108 may emulate a “fair play” device that is authorized to host and play the user's protected content. The content could then be experienced from devices not authorized to host the content (e.g. device 206), so long as they can receive streams from the server 108.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A method comprising:
a server system applying content and usage data from a user's client-side music and/or video library to determine recommended content to include in a playlist for the user.

2. The method of claim 1, further comprising:
applying the content and usage data from the client-side music and/or video library to determine recommended content for the playlist that is not content comprised by the client-side music and/or video library.

3. The method of claim 1, further comprising:
determining recommended content and forming a playlist that conforms to DMCA radio station regulations.

4. The method of claim 1, further comprising:
forming a client-side playlist comprising references to local content and references to content streamed from the server system.

5. The method of claim 4, further comprising:
providing a client-side control to determine a ratio in the client-side playlist of content from the user's library and content recommendations streamed from the server that are not in the user's library.

6. The method of claim 1, further comprising:
the server system applying information about the user's location to determine content for the playlist.

7. The method of claim 6, further comprising:
determining content for the playlist based multiple parties at the user's location.

8. The method of claim 6, further comprising:
playing content from the playlist as ambient music and/or video at the location.

9. The method of claim 1, further comprising:
preferably playing content defined by the playlist to the user from sources local to the client, and streaming the content from the server otherwise.

10. The method of claim 1, further comprising:
selecting content for the playlist related to one or more of a person, show, event, subject, place, product, or activity that is being browsed, watched, or listened to.

11. The method of claim 1, further comprising:
a client-side control for setting a ratio of content in the playlist, the ratio being of content currently in the user's library and content recommended by the server system that is not currently in the user's library.

12. The method of claim 11, wherein the client-side control for setting a ratio of content in the playlist further comprises:
a one or two-dimensional slider control.

13. The method of claim 12, further comprising:
uploading content protected by digital rights management from the client device to the server, the server emulating a device that may host and play the user's protected content.

14. A system comprising:
logic to apply content and usage data uploaded from a user's client-side music and/or video library to determine recommended content to include in a playlist for the user.

15. The system of claim 14, further comprising logic to: determine recommended content and form a playlist that conforms to DMCA radio station regulations.

16. The system of claim 14, further comprising logic to:
form a client-side playlist comprising references to local content and references to content streamed from the server system.

17. The system of claim 16, further comprising logic to:
provide a client-side control to determine a ratio in the client-side playlist of content from the user's library and content recommendations streamed from the server that are not in the user's library.

18. The system of claim 14, further comprising logic to:
apply information about the user's location to determine content for the playlist.

19. The system of claim 14, further comprising logic to:
preferably play content defined by the playlist to the user from sources local to the client, and to stream the content from the server otherwise.

20. The system of claim 14, further comprising logic to:
select content for the playlist related to one or more of a person, show, event, subject, place, product, or activity that is being browsed, watched, or listened to.
